(19) United States
(12) Patent Application Publication
(10) Pub. No.: US 2019/0108772 A1
(43) Pub. Date: Apr. 11, 2019

(54) METHOD AND APPARATUS FOR MULTILINGUAL INTERACTIVE SELF-LEARNING

(71) Applicant: Devanshu Kalra, Noida (IN)

(72) Inventor: Devanshu Kalra, Noida (IN)

(21) Appl. No.: 16/092,437

(22) PCT Filed: Feb. 20, 2017
(86) PCT No.: PCT/IN2017/000042

§ 371 Date: Oct. 9, 2018

(30) Foreign Application Priority Data
Apr. 9, 2016 (IN) 201611012526
Nov. 3, 2016 (IN) 201611037655

(51) Int. Cl. G09B 19/06; G09B 5/06; G09B 21/00; G06K 7/10; H04B 5/00

(52) U.S. Cl. CPC G09B 19/06; G09B 5/065; H04B 5/0062; G06K 7/10297; G09B 21/003

(57) ABSTRACT

In accordance with an example embodiment of the present invention a system comprises a console and a card wherein the console comprises a processor, a receiver configured to receive a short range wireless signal, and based on a short range wireless signal received by the receiver, the processor is configured to identify a media file stored in a memory location accessible to the processor and the short range wireless signal received by the receiver is associated with an object and a natural language, and the card comprises a short range wireless communication tag wherein the card has an image either printed or embossed on at least one of its surfaces or the card has a Braille representation on one of its surfaces.

### RELATED APPLICATIONS

This application claims priority to the provisional Indian Application No. 201611012526, titled MULTILINGUAL INTERACTIVE SELF LEARNING DEVICE, filed 9 Apr. 2016 and the complete Indian patent application assigned the same application number filed on May 5, 2016, both of which are hereby incorporated by reference in their, entirety.

### TECHNICAL FIELD

The present application relates generally to multilingual learning.

### BACKGROUND

Most current education systems use one language as a primary language of education and do not provide a multilingual learning environment. Even in situations where there is a desire to impart multi lingual education, for example by an educator in a school or by a parent at home, the methodology is usually that the educator/parent needs to translate words from one language to another (for example, from English to a native language) and relate that word to the person being taught. However, even this methodology has not been followed consistently by most education systems across the world and even at home it tends to be too tedious to be followed on a consistent basis.

A person who has been imparted education in a single language suffers from unnecessary burden later on in life when he/she has to learn a new language. This invention is inspired by worldwide lack of teachers with multilingual capability and lack of quality learning systems based on multilingual approach.

Korean patent application no. KR20090032777 discloses a robot for teaching many languages and recognizing an object by using RFID (Radio Frequency ID), RF and IrDA (Infrared Data Association) communication to output multilingual and audio-visual study data, and MP3 (MPEG (Moving Picture Expert Group) layer 3) data of animations and children's songs through a speaker and monitor by remotely recognizing data of an RFID tag which is attached to an object to be learned. A learning object comprises an, RFID tag, an RF communication unit and an IrDA transmitting/receiving sensor. A central processing unit recognizes the code value related to the learning object, and then outputs voice data corresponding to the corresponding code or performs a motor driving command. RF/IrDA processing units confirm command data of the IrDA transmitting/receiving sensor and RF communication unit attached to the learning object through RF/IrDA transceivers, apply the command data to the central processing unit, and then outputs study contents after recognizing the code value of the learning object.

However, there are significant differences between the disclosure in KR20090032777 and the present invention. For example, KR20090032777 discloses an object recognition system whereas the present invention is a system for learning a language. Furthermore, KR20090032777 teaches how objects can be learnt. However in the present invention, objects are associated with cards and an actual object need not be available to a user of the invented apparatus and system.

The present invention meets the requirements of a multi lingual learning system with an easy to use device which can be used by users in multiple languages and in multiple countries. This invention is readily useable by visually-disabled and hearing impaired users. The invention is especially useful among working parents, uneducated parents and poverty stricken parents.

### SUMMARY

Various aspects of examples of the invention are set out in the claims.

According to an aspect of the present invention, an apparatus comprises a processor, a receiver configured to receive a short range wireless signal, wherein based on a short range wireless signal received by the receiver, the processor is configured to identify a media file stored in a memory location accessible to the processor and the short range wireless signal received by the receiver is associated with an object and a natural language

According to another aspect of the invention, a system comprises a console and a card wherein the console comprises a processor, a receiver configured to receive a short range wireless signal, and based on a short range wireless signal received by the receiver, the processor is configured to identify a media file stored in a memory location accessible to the processor and the short range wireless signal received by the receiver is associated with an object and a natural language, and the card comprises a short range wireless communication tag such as a RFID tag or a NFC tag, wherein the card has an image either printed or embossed on at least one of its surfaces or the card has a Braille representation on one of its surfaces.

### BRIEF DESCRIPTION OF THE DRAWINGS

For a more complete understanding of example embodiments of the present invention, reference is now made to the following descriptions taken in connection with the accompanying drawings in which:

FIG. 1 illustrates an apparatus in accordance with an example embodiment of the invention;

FIG. 2 is a flow diagram showing operations according to an embodiment of the invention;

FIG. 3 illustrates a system in accordance with an embodiment of the invention.

### DETAILED DESCRIPTION OF THE DRAWINGS

The embodiments of the present invention relate to a system and apparatus for learning a language where a user can select a language to be learnt and specific words in the language to be learnt. The system is simple enough to be used by children and sophisticated enough to be used by visually challenged users.

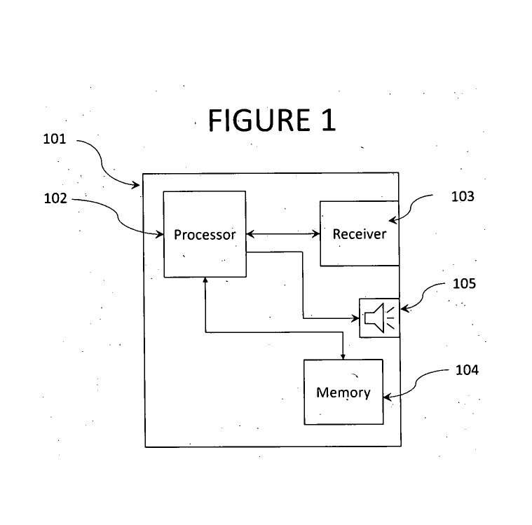

FIG. 1 illustrates a console 101 according to an embodiment of the invention. Console 101 comprises a processor 102, a receiver 103, a memory 104 and a speaker 105.

The receiver 103 is configured to receive short range wireless signals such as RFID (Radio Frequency Identification) signals or NFC (Near Field Communication) signals. Such signal are typically, but not always, low power signals. The received signals can be processed to identify at last one media file stored in a memory location accessible to the processor 102. A media file may represent a word in a natural language for an object and as such, the received signal may depend on an object and a natural language pronunciation of that object, chosen by a user of the console. The receiver may provide a received signal to the processor 102 or the receiver may itself process a received signal and provide an identifier of a media file with which the received signal is determined to be associated, to the processor 102.

Memory 104 is configured to store media files, such as sound and image files, corresponding to objects in at least one, but possibly more than one natural language. Memory 104 may be an internal memory of the console 101 or may be in form of an external memory device such as a USB memory device connected to a USB port of the console. Memory 104 may store a plurality of media files associated with a single object, each media file corresponding to a natural language word associated with the object. For example, memory 104 may store a sound file such as a “way” or “mp3” file, corresponding to an object, “apple”. One sound file corresponding to “apple” may be the pronunciation for the word “apple” in the English language. Another sound file corresponding to “apple” may be the pronunciation for the word for apple in the Hindi language. Correspondingly, memory 104 may store sound file corresponding to apple in a plurality of other languages. Furthermore, memory 104 may store one or more image or video files, such as “jpg” or “mp3” files, associated with apple. Memory 104 may store media files associated with a plurality of objects, even a whole dictionary of a natural language. The media files may be pre stored in the memory, or they may be downloaded from an external source to the memory.

Processor 102, based upon an input from the receiver 103 identifies one or more media files stored in the memory 104. The processor provides the identified media file(s) to the speaker 105. Speaker 105 plays the media file so as to output it to a user of the console.

Console 101 may additionally comprise a screen for outputting image or video files corresponding to an object.

Console 101 may additionally comprise one or more of (1) an ON/OFF switch in order to switch the console on or off, (2) a stand to adjust the viewing angle of the console, (3) a volume adjustment device, such as a slider, to enable a user to increase or decrease the amplitude of audio output of the console, (4) wall hanging keyholes to enable the console to be hung on a wall.

Furthermore, the console may be battery operated or configured to draw power from a power outlet, such as from a wall socket.

Furthermore, the processor may be configured to switch ON the console automatically when a card equipped with a short range wireless communication tag is brought in a vicinity of the console.

Furthermore, the console may be equipped with an inactivity timer to switch off the console after a predetermined period of inactivity.

In an example embodiment of the invention, the console may be equipped with a headphone jack and/or a USB port.

In a further embodiment of the invention, the console comprises one or more motion sensors which enable the processor 102 to detect movement in a vicinity of the console whereby the processor may activate an audio output via a speaker or a visual output, such as a welcome message, via a screen, upon detection of movement by a motion sensor. Such an audio and/or visual stimulation may motivate a user to interact with the console in order to learn a language.

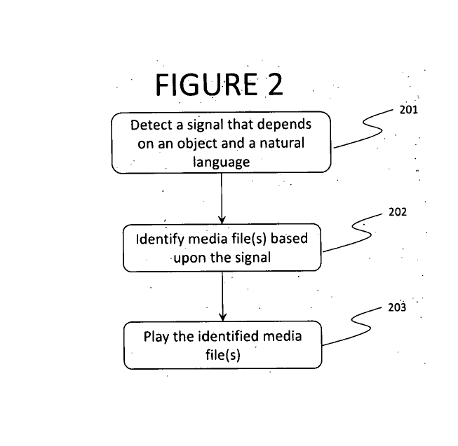

FIG. 2 is a flow diagram showing operations according to an embodiment of the invention. In step 201, a receiver of the console receives a signal that depends on an object and a natural language. This signal could be received from an external device, such as a card, equipped with a RFID tag or a NFC tag when the device is in the vicinity of the console. The card is preferably associated with the object by means of having an image of the object printed or embossed on one of its surface. The card may optionally or exclusively have a Braille representation of the object on one of its surface and hence be associated with the object. In addition, the card is associated with a natural language. In step 202, a processor in the console identifies one or more media files associated with the object and the language. The object and the language combination may be associated with a unique code and a memory of the console may store a sound file and/or an image file associated with the code. In step 203, the sound file is played via a speaker of the console. Additionally, an image/video file associated with the object may be displayed via a screen of the console. Additionally, a projector of the console may project an image/video file associated with the object on a screen external to the console.

In an example embodiment of the invention, a user would have purchased one or multiple decks of cards, each deck corresponding to a natural language such as Hindi, English, Spanish, etc. Each card in a deck of cards has one or more media files associated with it, wherein the media files are not stored physically on the card itself. These media files could be made available to a user in form of an external memory devices such as a USB memory device which can be connected to a console or these media files could be made available to a user on a website whereby the media files could be downloaded to a console. To enable such a download, the console may be equipped with connectivity capabilities such as Wi-Fi or Bluetooth™. In yet another embodiment of the invention, media files associated with a deck of cards could be pre stored on the console and by making a payment, a user could unlock such a set of pre stored media files. A set of media files could additionally be encrypted via a digital encryption scheme.

In order to use a system according to the invention, a user needs to have a deck of cards and media files corresponding to the deck of cards need to be available to a console assessable to the user. Each card in a deck of cards is capable of short range wireless communication with the console by means of a short range wireless communication tag such as a RFID tag or a NFC tag. Each card in a deck of cards is associated with an object and one or more natural languages.

In an example use case of the invention, a user may purchase a deck of RFID cards for a natural language of choice such as English or Hindi. Media files associated with the deck of cards may already be pre-stored in a memory of the console. When a user brings an RFID card in a vicinity of the console, the console recognises the object whose image is either printed, embossed or the object that is represented in Braille on the RFID card. The console also recognizes the language(s) that is/are associated with the card. The console may then do one or more of the following: (1) produce a sound corresponding to the word for the object in as many languages as the user has selected, in a sequential manner (2) display an image of the object on the console screen (2) project the image of the object on an external surface such as, a wall or screen, via the console projector.

In another example embodiment of the invention, a user may purchase a deck of RFID cards along with a username and password and a www link to a webpage where the user can register the product. After the purchase is registered online, the console is permitted to download data from a server, including media files associated with a deck of cards. The user may then connect the device to the Internet via any of the known techniques such as Wi-Fi or data cable with pre-provided authentication key written on the back of the console and the console will download data corresponding to the purchased deck of cards.

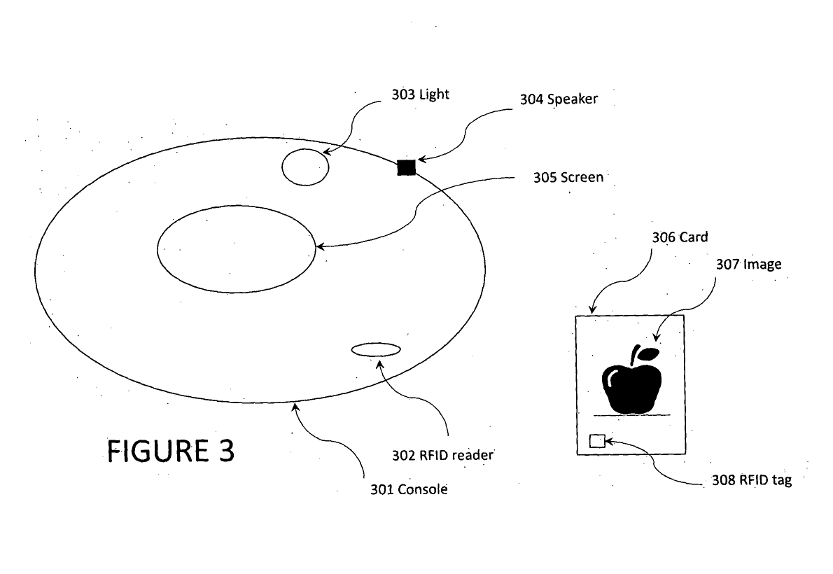

FIG. 3 illustrates a system in accordance with an embodiment of the present invention. The system comprises a console 301 and a card 306. The card 306 comprises an image 307 of an object (say, an apple). Additionally, the card is associated with at least one natural language, say, English. Optionally or additionally, the card may have the image embossed on the card. Optionally or additionally, the card may have a Braille representation of the object. The RFID tag 308 attached to the card is able to communicate with a RFID reader, such as the RFID reader 302 of the console 301. A user brings the card 306 in a vicinity of the console 301. The RFID reader 302 reads the RFID tag 308 and the light 303 is illuminated to indicate to a user that the card has been read by the console. Optionally or additionally, the console may produce a sound to indicate to a user that the card has been read by the console. In a further embodiment of the invention, the console may be configured to vibrate to indicate to a user that the card has been read by the console. Thereafter, a determination is made at the console as to the identity of a media file associated with the image, in this case, “apple” and the natural language with which card 306 is associated. Once the media file is identified at the console, the speaker 304 outputs the name of the object in the language(s) associated with the card, in a predefined order. Optionally, the console may display an image of the object on the screen 305. Optionally, the console may comprise a projector which may project an image of the object on an external surface such as a wall or a screen.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as, defined in the appended claims.

1-20. (canceled)

21. An apparatus for providing multilingual learning to a user, the apparatus comprising:
a memory capable of storing a plurality of media files, wherein the plurality of media files are associated with at least one object;
a receiver adapted to receive short range wireless signal, wherein the short range wireless signal comprises an identifier associated with the at least one object;
a processor adapted to identify one or more media files out of the plurality of media files stored in the memory, wherein the identification is based on the identifier received from the receiver; and
an output unit adapted to play the identified one or more media files in a sequential manner.

22. The apparatus as claimed in claim 21, wherein the receiver is an RFID reader and the short range wireless signal is an RFID signal.

23. The apparatus as claimed in claim 22, wherein the object is associated with the RFID tag.

24. The apparatus as claimed in claim 21, wherein the receiver is a NFC tag reader and the short range wireless signal is a NFC signal.

25. The apparatus as claimed in claim 24, wherein the object is associated with the NFC tag.

26. The apparatus as claimed in claim 21, wherein the one or more media files are played in sequential manner with audio files being played first followed by video files.

27. The apparatus as claimed in claim 26, wherein the one or more media files are played in sequential manner with a natural language file being played first, followed by translation of the name of the at least one object in other languages.

28. The apparatus as claimed in claim 21, wherein the media file is downloaded to the memory from an external information source.

29. The apparatus as claimed in claim 28, wherein the media file is downloadable from the World Wide Web.

30. The apparatus as claimed in claim 28, wherein the media file is stored on an external memory device.

31. The apparatus as claimed in claim 21, further comprising at least one motion sensor to detect movement in a vicinity of the apparatus.

32. The apparatus as claimed in claim 21, further comprising a light source, wherein the light source is activated to indicate that the apparatus has received a short range wireless signal.

33. The apparatus as claimed in claim 21, comprising a visual user interface to display the object.

34. The apparatus as claimed in claim 21, comprising a projector for projecting an image associated with the object on an external surface.

35. A system for providing multilingual learning to a user, the system comprising:
at least one card comprising a short range wireless communication tag, wherein the card has an image printed on at least one of its surfaces;
an apparatus including:
a memory capable of storing a plurality of media files, wherein the plurality of media files are associated with at least one object;
a receiver adapted to receive a short range wireless signal, wherein the short range wireless signal comprises an identifier associated with the at least one object;
a processor adapted to identify one or more media files out of the plurality of media files stored in the memory, wherein the identification is based on the identifier received from the receiver; and
an output unit adapted to play the identified one or more media files in a sequential manner.

36. The system as claimed in claim 35, further comprising a Braille representation associated with the at least one object.
